(19) United States
(12) Patent Application Publication
(10) Pub. No.: US 2022/0048526 A1
(43) Pub. Date: Feb. 17, 2022

(54) METHOD AND APPARATUS FOR SELF-DIAGNOSIS, SELF-CALIBRATION, OR BOTH IN AN AUTONOMOUS OR SEMI-AUTONOMOUS VEHICLES

(71) Applicant: Continental Automotive Systems, Inc., Auburn Hills, MI (US)

(72) Inventors: Clinton L. Schumann, Holly, MI (US); Scott T. Sanford, Swartz Creek, MI (US); Geoff Bauer, Oxford, MI (US); Joseph A. LaBarbera, Auburn Hills, MI (US)

(21) Appl. No.: 16/993,483

(22) Filed: Aug. 14, 2020

(51) Int. Cl. B60W 50/08; B60W 40/114; B60W 50/04

(52) U.S. Cl. CPC B60W 50/085; B60W 2050/0083; B60W 50/045; B60W 40/114

(57) ABSTRACT

A number of illustrative variations may include a method of diagnosing and/or calibrating components in vehicles.

### FIELD

The field to which the disclosure generally relates, includes diagnosing and/or calibrating components in vehicles.

### BACKGROUND

Vehicles typically include systems that may need to be calibrated or monitored.

### SUMMARY

A number of illustrative variations may include a method of an autonomous or semi-autonomous vehicle performing a self-diagnosis, self-calibration, or both.

A number of illustrative variations may include a method comprising: (a) initiating moving a vehicle in one or more predefined maneuvers; (b)comparing data collected during the one or more predefined maneuvers with at least one of prior data collected or initial data collected; and (c) analyzing the data from the comparing step to determine if at least one of calibration of one or more components of the vehicle is needed, if repair of one or more components of the vehicle is needed, or one or more components of vehicle is performing properly.

Other illustrative variations within the scope of the invention will become apparent from the detailed description provided hereinafter. It should be understood that the detailed description and specific examples, while disclosing variations of the invention, are intended for purposes of illustration only and are not intended to limit the scope of the invention.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

Select examples of variations within the scope of the invention will become more fully understood from the detailed description and the accompanying drawings, wherein:

FIG. 1 depicts an illustrative variation of a predefined maneuver.

FIG. 2 depicts an illustrative variation of a predefined maneuver and the systems being monitored.

FIG. 3 depicts an illustrative variation of a predefined maneuver and a selection of the predefined maneuver.

FIG. 4 depicts reporting a result.

### DETAILED DESCRIPTION

The following description of the variations is merely illustrative in nature and is in no way intended to limit the scope of the invention, its application, or uses.

A number of illustrative variations may include a system, a method, or both that assists a vehicle in self-diagnosis, self-calibration, or both. The system, method, or both may communicate self-diagnosis, self-calibration, or both to a user, an operation center, a transmission device, an operator device, or a combination thereof. The system may be part of a vehicle. The system may include or use only standard parts of a vehicle. The system may include an application (app) or program that is installed on hardware of the vehicle, a transmission device, an operator device, or a combination thereof. The system may be part of any vehicle. The system may be part of a computer, microprocessor, processor, or a combination thereof. The system may include software that is loaded into a computing device of a vehicle. The system may be located on memory and the memory may be installed in the computing device of a vehicle. The vehicle may be a car, motorcycle, bus, truck, semi-truck, SUV, XUV, four-wheeler, dirt bike, boat, commercial vehicle, construction vehicle, industrial vehicle, farm equipment, plane, helicopter, or a combination thereof. Preferably, the vehicle is a vehicle used on a roadway. The vehicle may be semi-autonomous or autonomous. At least one system of a vehicle may be used or operated to review if any system of the vehicle is in need of repair or calibration. One or more computer systems of the vehicle may use semi-autonomous or autonomous control of the vehicle to check at least one system of the vehicle. The semi-autonomous or autonomous control may communicate with a program or app to perform the self-diagnosis or self-calibration taught herein. The vehicle may monitor at least a transmission, steering, and braked. The systems of the vehicle that may be monitored may include at least a brake system a suspension system, and a steering system.

In a number of illustrative variations, the brake system of the vehicle may be monitored, diagnosed, calibrated, or a combination thereof. The brake system functions to slow or stop a vehicle. The brake system may include a fixed caliper, sliding caliper, electric parking brake, drum, drum in hat caliper, or a combination thereof. The brake system may be hydraulic or electric. A brake system or caliper may be located in each corner and each corner may be diagnosed, calibrated, or both. The brake system may include a rotor, one or more brake pads or brake shoes, two or more brake pads or shoes, a drum, or a combination thereof. The brake system may include or be in communication with a master cylinder, pressure sensor, brake booster, anti-lock controller, actuation unit, clamp force sensor, fluid pressure sensor, inertial measurement unit, or a combination thereof. The brake system may include hydraulic fluid. The brake system may be free of a hydraulic fluid. The brake system may include a motor, a master cylinder, or both. The brake system may include anti-locking. The brake system may control an amount of pressure created (e.g., braking force). The brake system may vary an amount fluid pressure to adjust a braking force. The brake system may vary an amount of voltage or amperage applied to a motor to adjust a braking force. The brake system may include at least one brake setting, monitor one or more brake settings, control one or more brake settings, calibrate one or more brake settings, alert one or more brake settings, or combination thereof. The brake settings may include applying anti-lock, braking to prevent anti-lock from engaging, changing a clamp force of brake, changing fluid pressure, or a combination thereof. The brake system, suspension system, steering system, or a combination thereof may be monitored, calibrated, or provide an alert during diagnosing.

In a number of illustrative variations, the suspension system functions to maintain tires in contact with the ground, improve the ride for a user, assist in braking a vehicle, or a combination thereof. The suspension system may be located in a forward end, a rearward end, or both of a vehicle. The suspension system may be located in each corner of a vehicle or proximate to each corner of a vehicle. The suspension system may include shocks, struts, or both. The suspension system may prevent the vehicle from rocking back and forth, side to side, a front end dipping down, a rear end lifting up, or a combination thereof. The suspension system may be tied to the transmission of a vehicle. For example, shifting of the transmission may cause the vehicle to move (e.g., a back end to dip) so that the suspension moves. The suspension system may be connected to a ride height sensor, an inertial measurement unit, a yaw rate, or a combination thereof. The suspension system may work in conjunction with or be monitored in conjunction with a steering system, a brake system, or both.

In a number of illustrative variations, the steering system functions to control movement of the vehicle, turn a vehicle, avoid objects, move the wheels, or a combination thereof. The steering system may maintain a vehicle traveling in a straight line. The steering system may move the front wheels, the rear wheels, or both. The steering system may move one or more wheels. The steering system may move two or more wheels. The steering system may move two wheels in one direction and two wheels in a different direction. The steering system may include or be connected to a steering wheel, steering column, tie bar, wheels, motors, controller, power steering pump, fluid lines, or a combination thereof. The steering system may be free of hydraulic fluid, a steering wheel, a steering column, or a combination thereof. The steering system may be moved using only motors. The steering system may be moved using hydraulic fluid. The steering system may be moved by a computer. The computer may communicate with one or more motors and the one or more motors may move the wheels of the vehicle.

In a number of illustrative variations, systems of the vehicle (e.g., steering system, braking system, suspension system) may be monitored, checked, diagnosed, or a combination thereof by initiating one or more predefined maneuvers. The predetermined maneuvers may be directed to one of the systems taught herein. The predetermined maneuvers may control one or more of the systems herein or to diagnose one or more of the systems herein (e.g., the transmission, the steering wheel, the brakes, or a combination thereof). The initiating of the predefined maneuvers may function to aid in determining if one or more systems are operating normally, all or parts of the system are wearing out, the system needs to be calibrated, the system needs to be repaired, or a combination thereof. The step of initiating maneuvers may be where a vehicle is controlled in a predetermined manner to ascertain if one or more systems is operating properly.

In a number of illustrative variations, the one or more predefined maneuvers may include controlling steering of the vehicle, braking of the vehicle, varying speed of the vehicle, shifting a transmission of a vehicle, changing brake settings of a vehicle, or a combination thereof. The predefined maneuvers may be steering the vehicle in a slalom (e.g., driving along a serpentine path), ramp (e.g., making a gradual turn (e.g. driving at a 45 degree angle), step (e.g., making 90 degree turns), straight configuration, or a combination thereof. The predefined maneuvers may include speeding up a vehicle, preventing shifting of the transmission, forcing shifting of the transmission, changing a braking force of a brake, maintaining a constant speed, accelerating a vehicle, decelerating a vehicle, changing a rate of acceleration, changing a rate of deceleration, drop throttling (e.g., flooring the vehicle and then releasing the gas pedal), driving in two wheel drive, driving in four wheel drive, changing transmission shift points, or a combination thereof. The predefined maneuvers may include a speed of about 25 kph or more, about 40 kph or more, about 65 kph or more, about 95 kph or more, or about 125 kph or less. The predefined maneuvers may include braking without using anti-locking, braking to prevent anti-lock from engaging, changing clamp force, changing fluid pressure in a caliper, changing voltage to a motor, or a combination thereof. The predefined maneuvers may include a plurality of variations in movement, speed, and stopping. For example, while driving in a slalom configuration the vehicle may speed up, stop, and shift gears. The step of initiating predefined maneuvers may include communicating with a user that the vehicle needs to be tested. The step of initiating may include moving the vehicle to a test area or operation center. The step of initiating may include selecting the predefined maneuvers to be performed based upon mileage, usage time, duration between uses, or a combination thereof. The step of initiating may include selecting any variation discussed herein that may be performed in any combination or any order so that the self-diagnosis may be performed. During initiating the semi-autonomous vehicle, the autonomous vehicle, or both may be summoned to an area where the vehicle can be safely tested, where a fleet may be monitored, where a fleet may be repaired, where a fleet may be calibrated, or a combination thereof. Once the vehicle is at a predetermined location and the predefined maneuvers are selected a step of testing may be performed.

In a number of illustrative variations, the step of testing functions to move the vehicle so that the sensors and systems may be monitored to determine whether the system is working properly. For example, if the brake system is being tested, the step of testing may measure stopping distance and braking force while slowing the vehicle from a predetermined speed (e.g., 48 kph). If the stopping distance is greater than a predetermined distance it may indicate that the brake system needs to be checked. It may also indicate that the suspension system needs to be monitored. The step of testing may change the monitoring systems into a diagnosis mode. The step of testing may turn on more monitoring systems. The step of testing may divert processing power from some systems to the monitoring systems so that the monitoring systems may monitor with a higher accuracy. The step of testing may only turn on parts of the monitoring systems that are needed to monitor based upon a predefined maneuver that has been selected and may be being performed. The testing step may be performed one or more times depending on a number of predetermined maneuvers that are selected. The testing steps may be performed in sequence to check each of the systems for a given testing session. The testing steps may be performed, then a compare step, then an analyze step, and then optionally the testing step or selection step of predetermined maneuvers may be repeated one or more times. The compare step, the analyze step, or both may be skipped. For example, if in the testing step the sensors indicate that a component is not functioning then an alarm may be indicated and the remaining steps may be skipped.

In a number of illustrative variations, the compare step functions to compare currently measured date with initial data, previous data, or both. For example, if the vehicle performed a slalom and a ramp or step the two sets of data may be compared. The compare step may be performed one or more times for one testing session or one step of testing. The compare step may be performed after one or more tests, two or more tests, or three or more tests. The compare step may compare two concurrent tests to each other to determine if a calibration was successful, a repair was successful, if more testing needs to be performed, to establish a baseline, or a combination thereof. The compare step may compare testing to data collected during normal operation. The compare step may only compare data collected during execution of a predefined maneuver to data collected during a same predefined maneuver during a prior or subsequent execution of the predefined maneuver. The compare step may determine a change between compared data. The compare step may determine a deviation from a test performed when all or a portion of the vehicle was new. The compare step may take compared data and then analyze the data in an analyze step.

In a number of illustrative variations, the analyze step functions to determine if a system is operating normally, if calibration is needed, if a repair is needed, or a combination thereof. The analyze step may review a change relative to measurements from a new vehicle, between two tests of a vehicle, or both. The analyze step may monitor the change from new through multiple testing sessions. The analyze step may monitor each of the changes or each of the compare data from the compare step to determine how the system or the vehicle is reacting over time. The analyze step may analyze raw data. The analyze may analyze versus aggregated data. For example, if there is a fleet of the same model and year vehicle then the analysis may occur based upon an average result of a test. Thus, if one vehicle is better than the average result the vehicle may be considered in good working condition. In another example, if a vehicle is below average then more testing may be needed, repairs may be needed, calibration may be performed, or a combination thereof. The analyze step may analyze both raw data from the testing step and data from the compare step or relative to a fleet average. The analyze step may determine if more testing needs to be performed. For example, the analyze step may determine that the vehicle did not perform a slalom in an estimated manner so another predefined maneuver (e.g., relative to fleet performance or prior performance) may be selected and another test performed. The analyze step may analyze to determine if any action needs to be performed. The analyze step may indicate if one or more parts need to be adjusted, calibrated, repaired, continue to be monitored, are operating properly, or a combination thereof. The analyze step may suggest adjustments to be made to a vehicle.

In a number of illustrative variations, the adjustment step functions to electrically change configurations of a vehicle, indicate parts to repair, indicate parts to replace, calibrate motors, calibrate pumps, calibrate a transmission, calibrate a brake system, calibrate a suspension system, calibrate a steering system, adjust a transmission, adjust a brake system, adjust a suspension system, adjust a steering system, adjust a motor, adjust brake pressure, adjust a ride height sensor, or a combination thereof. The adjustment step may be performed by a machine, a controller, a software upgrade, a software change, a mechanic, or a combination thereof. The adjustment step may be performed at a fleet management center, an operation center, a garage, a user's home, in a repair trailer, or a combination thereof. The adjustment step may adjust operation of one of the systems so that performance is within a predetermined or desired range. The adjustment step may be performed one or more times. After an adjustment step is performed the process may be repeated or the vehicle may be returned to a user. After the adjustment step a selection step may be performed again, a new predetermined maneuver may be selected, or a combination thereof. The adjustment step, results of the adjustment step, or both may be performed at or provided to a transmission device, operation center, operator device, or a combination thereof.

In a number of illustrative variations, one or more transmission devices may function to communicate between a vehicle and a user, an operation center, an operator device, a mechanic, or a combination thereof. The one or more transmission device may be a satellite, a transmission tower, part of a cellular network, near field communications, or a combination thereof. The transmission device may transmit over the internet. The transmission device may be used to send emails, texts, reminders, or a combination thereof. The transmission device be used only as a relay station. The transmission device may communicate between an operation center, a vehicle, an operator device, or a combination thereof.

In a number of illustrative variations, an operation center may function to be a hub where all or a portion of a fleet are tested, calibrated, repaired, stored, recharged, cleaned, or a combination thereof. The operation center may be regionally located. For example, the operation center may be a central hub were a fleet is kept, tested, maintained, or a combination thereof for a state, county, city, or a combination thereof. The operation center may be a location where mechanics work and the vehicles move to for testing, repair, calibration, or a combination thereof. For example, at night when the vehicle is no longer being used the vehicle may drive itself to the operation center for testing. The operation center may house vehicles and then when a user summons a vehicle the vehicle may leave the operation center and drive to pick up the user. The operation center may have a testing area. The operation center may be in communication with a user, a transmission device, an operator device, or a combination thereof.

In a number of illustrative variations, the system may be in communication with an operator device. The operator may function to provide communications to a user, provide communications from a vehicle, provide communications from an operation center, provide communications from a transmission device, or a combination thereof. The operator device may allow for two-way communications between a user and a vehicle. The operator device may use texts, emails, voice commands, recordings, or a combination thereof to provide communication. The operator device may be a phone, a computer, a tablet, or a combination thereof.

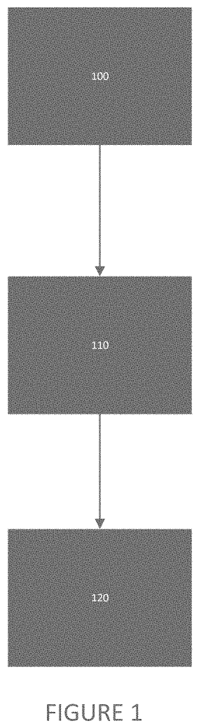

Referring now to FIG. 1, which is an illustrative variation of self-calibration or self-diagnosis of a vehicle by initiating predefined maneuvers in an initiation step 100. The data from the initiation step 100 may be compared to initial data, previous data, or both in a compare step 110 and then the data may be analyzed in an analyze step 120 to determine if calibration, repairs, no action, or a combination thereof are needed.

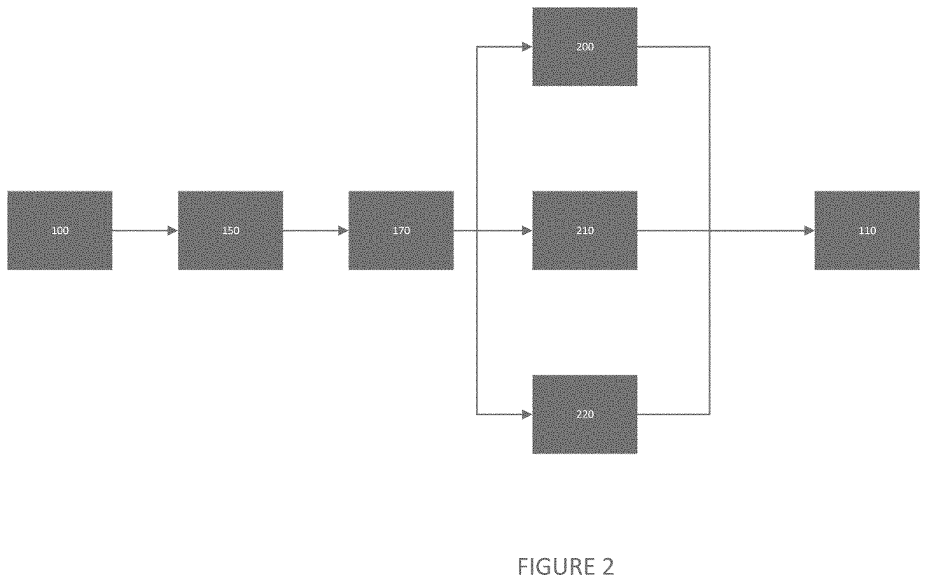

Referring now to FIG. 2, an illustrative variation where an initiate step 100 commences and a type of predetermined maneuver may be selected in a section step 150 and vehicle adjustments to be made during the predetermined maneuver are made in an adjustment step 170. The selection step 150 and adjustment step 170 are based on if the system desires to diagnose the brake system 200, suspension system 210, steering system 220, or a combination of the systems. Data collected may be then sent to a processor where the data may be compared to prior data or initial data in a compare step 110.

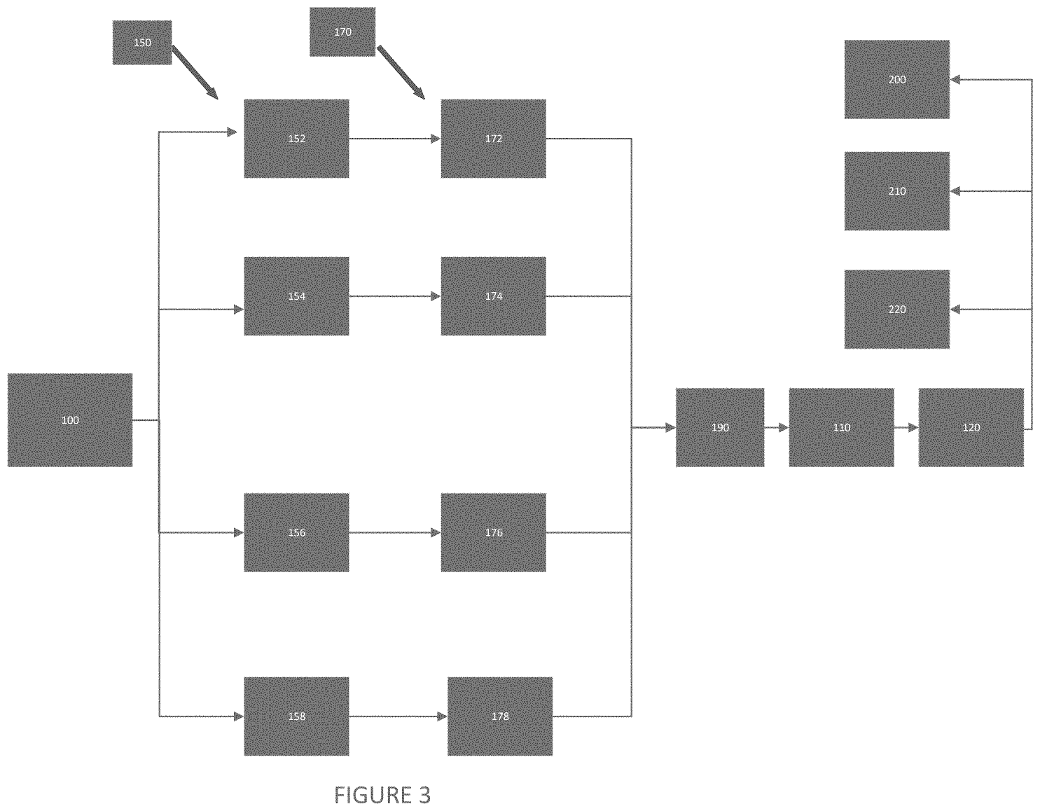

Referring to FIG. 3, an illustrative variation in which an initiation step 100 begins a predefined set of maneuvers. The predefined maneuvers are chosen from predetermined maneuvers in a selection step 150 where the predetermined maneuvers are slalom 152, ramp 154, step 156, or straight 158. Once the selection step 150 may be complete an adjustment step 170 occurs where a type of predetermined vehicle adjustment may be selected. The adjustment step 170 selects from the predetermined vehicle adjustments which include speed 172, transmission 174, steering 176, and braking 178. Once the selection step 150 and adjustment step 170 are completed the testing may be performed in a testing step 190. Data from the testing step 190 may be then used in a comparing step 110. The results from the comparing step 110 may be then analyzed in an analyze step 120 to determine if calibration may be needed, a repair may be needed, no action may be needed, or a combination thereof. If calibration may be needed then the brake system 200, suspension system 210, steering system 220, or a combination thereof are then calibrated or a message may be created regarding the repair needed for one or more of the systems by communicating with the brake system 200, suspension system 210, steering system 220, an operator, mechanic, operation center, or a combination thereof.

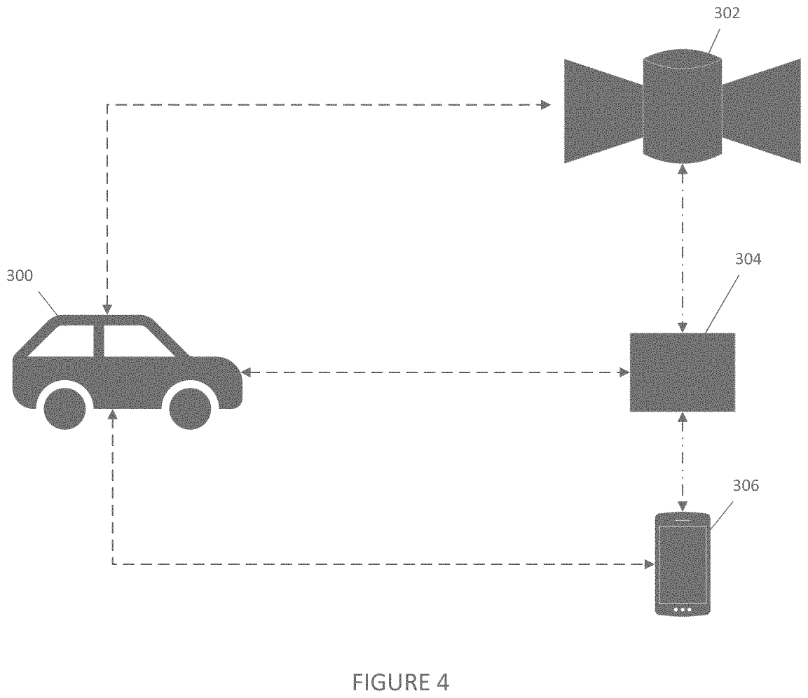

FIG. 4 illustrates communication of results of running the predetermined maneuvers between a vehicle 300 and a transmission device 302, operation center 304, and operator device 306. The transmission device 302, operation center 304, operator device 306, or all any combination may be in communication with one another.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the teachings herein.

Variation 1 may comprise a method comprising: (a) initiating moving a vehicle in one or more predefined maneuvers; (b) comparing data collected during the one or more predefined maneuvers with at least one of prior data collected or initial data collected; and (c) analyzing the data from the comparing step to determine if at least one of calibration of one or more components of the vehicle is needed, if repair of one or more components of the vehicle is needed, or one or more components of vehicle is performing properly.

Variation 2 may comprise the method of variation 1 and any number or combination of variations 3-20 wherein the step of initiating includes a step of selecting one or more types of predefined maneuvers.

Variation 3 may include the method of variation 1 and any number or combination of variations 2 and 4-20 wherein the one or more types of predefined maneuvers are moving the vehicle in at least one of a slalom, ramp, step, or straight configuration.

Variation 4 may include the method of variation 3 and any number or combination of variations 1-2 and 5-20 wherein the step of initiating includes a step of includes a step of adjusting one or more configurations of the vehicle.

Variations 5 may include the method of variation 4 and any number or combination of variations 1-3 and 6-20 wherein the one or more configurations of the vehicle includes at least one of speed of the vehicle, transmission settings of the vehicle, steering settings of the vehicle, or brake settings of the vehicle.

Variation 6 may include the method of variation 5 and any number or combination of variations 1-4, and 7-20 wherein the speed of the vehicle includes maintaining at least one of a constant speed, accelerating, decelerating, rate of acceleration, rate of deceleration, or drop throttling.

Variation 7 may include the method of variation 5 and any number or combination of variations 1-4, 6, and 8-20 wherein the transmission settings includes at least one of two-wheel drive, four-wheel drive, or transmission shift points.

Variation 8 may include the method of variation 5 and any number or combination of variations 1-4, 6-7, and 9-20 wherein the brake settings includes at least one of braking using anti-lock, braking to prevent anti-lock from engaging, changing clamp force of a brake, changing fluid pressure, or changing voltage to a motor.

Variation 9 may include the method of variation 5 and any number or combination of variations 1-4, 5-8, and 10-20 wherein the steering settings includes at least one of fluid pressure or alignment.

Variation 10 may include the method of variation 1 and any number or combination of variations 2-8 and 11-20 wherein the method includes a step of testing the vehicle by the vehicle moving through the one or more predefined maneuvers.

Variation 11 may include the method of variation 10 and any number or combination of variations 1-8 and 12-20 wherein data collected during the step of testing the vehicle is delivered to at least one of a processor, a processing center, a computer, or a micro-processor.

Variation 12 may include the method of variation 10 and any number or combination of variations 2-8 and 13-20 wherein the data from the step of testing the vehicle is compared and analyzed in the comparing step and the analyzing step respectively.

Variation 13 may include the method of variation 12 and any number or combination of variations 1-11 and 14-20 wherein results of the step of comparing and the step of analyzing are feedback to at least one of a brake system, a suspension system, or a steering system so that at least one of the brake system, the suspension system, or the steering system are calibrated.

Variation 14 may include the method of variation 12 and any number or combination of variations 1-11, 13, and 15-20 wherein results of the step of comparing and the step of analyzing are provided to at least one of a transmission device, an operation center, or an operator device.

Variation 15 may include the method of variation 14 and any number or combination of variations 1-13 and 16-20 wherein at least one of the transmission device, the operator center, or the operator device recall the vehicle to be repaired or calibrated based upon the results.

Variation 16 may include the method of variation 1 and any number or combination of variations 2-15, and 17-20 wherein the vehicle includes: at least one of a brake system, a suspension system, or a steering system, and the steps of initiating includes: includes a step of selecting one or more types of predefined maneuvers including moving the vehicle in at least one of a slalom, ramp, step, or straight configuration; and includes a step of includes a step of adjusting one or more configurations of the vehicle including at least one of speed of the vehicle, transmission settings of the vehicle, steering settings of the vehicle, or braking settings of the vehicle.

Variation 17 may include the method of variation 16 and any number or combination of variations 1-15 and 18-20 wherein the method includes a step of monitoring includes at least one of a master cylinder, motor, pressure sensor, brake booster, anti-lock controller, actuation unit, clamp force, fluid pressure, or inertial measurement unit of the brake system.

Variation 18 may include the method of variation 16 and any number or combination of variations 1-15, 17, 19, and 20 wherein the method includes a step of monitoring at least one of an inertial measurement unit, a ride height sensor, longitudinal acceleration, or pitch sensor of the suspension system or the vehicle.

Variation 19 may include the method of variation 16 and any number or combination of variations 1-15, 17-18, and 20 wherein the method includes a step of monitoring at least one of an inertial measurement unit, yaw rate, or a ride height sensor of the vehicle.

Variation 20 may include the method of variation 16 or any number or combination of variations 1-15 and 17-19 wherein the method includes a step of monitoring at least one of lateral acceleration, wheel speed sensors, electric motor speed sensors, driveline sensors, steering sensors, tire sensors, GPS sensors, cameras, radars, and lidars.

The above description of select variations within the scope of the invention is merely illustrative in nature and, thus, variations or variants thereof are not to be regarded as a departure from the spirit and scope of the invention.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

100 (initiate step) Initiate Predefined Maneuvers

110 (Compare step) Compare Data to Initial Data, Previous Data, or both

120 (Analyze step) Determine if calibration or repair is needed

150 (selection step) Type of Predefined Maneuver

152 Slalom

154 Ramp

156 Step

158 Straight

170 (adjustment step) Type of Vehicle Adjustment

172 Speed

174 Transmission

176 Steering

178 Braking

190 Testing step

200 Brake System

210 Suspension system

220 Steering system

300 Vehicle

302 Transmission Device

304 Operation Center

306 Operator Device

What is claimed is:

1) A method comprising:
a) initiating moving a vehicle in one or more predefined maneuvers;
b) comparing data collected during the one or more predefined maneuvers with at least one of prior data collected or initial data collected; and
c) analyzing the data from the comparing step to determine if at least one of calibration of one or more components of the vehicle is needed, if repair of one or more components of the vehicle is needed, or one or more components of vehicle is performing properly.

2) The method of claim 1, wherein the step of initiating includes a step of selecting one or more types of predefined maneuvers.

3) The method of claim 2, wherein the one or more types of predefined maneuvers are moving the vehicle in at least one of a slalom, ramp, step, or straight configuration.

4) The method of claim 1 wherein the step of initiating includes a step of includes a step of adjusting one or more configurations of the vehicle.

5) The method of claim 4, wherein the one or more configurations of the vehicle includes at least one of speed of the vehicle, transmission settings of the vehicle, steering settings of the vehicle, or brake settings of the vehicle.

6) The method of claim 5, wherein the speed of the vehicle includes maintaining at least one of a constant speed, accelerating, decelerating, rate of acceleration, rate of deceleration, or drop throttling.

7) The method of claim 5, wherein the transmission settings includes at least one of two-wheel drive, four-wheel drive, or transmission shift points.

8) The method of claim 5, wherein the brake settings includes at least one of braking using anti-lock, braking to prevent anti-lock from engaging, changing clamp force of a brake, changing fluid pressure, or changing voltage to a motor.

9) The method of claim 5, wherein the steering settings includes at least one of fluid pressure or alignment.

10) The method of claim 1, wherein the method includes a step of testing the vehicle by the vehicle moving through the one or more predefined maneuvers.

11) The method of claim 10, wherein data collected during the step of testing the vehicle is delivered to at least one of a processor, a processing center, a computer, or a micro-processor.

12) The method of claim 10, wherein the data from the step of testing the vehicle is compared and analyzed in the comparing step and the analyzing step respectively.

13) The method of claim 12, wherein results of the step of comparing and the step of analyzing are feedback to at least one of a brake system, a suspension system, or a steering system so that at least one of the brake system, the suspension system, or the steering system are calibrated.

14) The method of claim 12, wherein results of the step of comparing and the step of analyzing are provided to at least one of a transmission device, an operation center, or an operator device.

15) The method of claim 14, wherein at least one of the transmission device, the operator center, or the operator device recall the vehicle to be repaired or calibrated based upon the results.

16) The method of claim 1, wherein the vehicle includes: at least one of a brake system, a suspension system, or a steering system, and the steps of initiating includes:
a step of selecting one or more types of predefined maneuvers including moving the vehicle in at least one of a slalom, ramp, step, or straight configuration; and
a step of includes a step of adjusting one or more configurations of the vehicle including at least one of speed of the vehicle, transmission settings of the vehicle, steering settings of the vehicle, or braking settings of the vehicle.

17) The method of claim 16, wherein the method includes a step of monitoring includes at least one of a master cylinder, motor, pressure sensor, brake booster, anti-lock controller, actuation unit, clamp force, fluid pressure, or inertial measurement unit of the brake system.

18) The method of claim 16, wherein the method includes a step of monitoring at least one of an inertial measurement unit, a ride height sensor, longitudinal acceleration, or pitch sensor of the suspension system or the vehicle.

19) The method of claim 16, wherein the method includes a step of monitoring at least one of an inertial measurement unit, yaw rate, or a ride height sensor of the vehicle.

20) The method of claim 16, wherein the method includes a step of monitoring at least one of lateral acceleration, wheel speed sensors, electric motor speed sensors, driveline sensors, steering sensors, tire sensors, GPS sensors, cameras, radars, and lidars.
